(19) United States
(12) Patent Application Publication
(10) Pub. No.: US 2008/0249914 A1
(43) Pub. Date: Oct. 9, 2008

(54) Fixed-Reference Money System Based on Electrical Capacity

(76) Inventor: Robert W. Hahl, Falls Church, VA (US)

Correspondence Address: Robert W. Hahl, 121 S. Lee St., Falls Church, VA, 22046, US

(21) Appl. No.: 11/696,038

(22) Filed: Apr. 3, 2007

(51) Int. Cl. G06Q 40/00

(52) U.S. Cl. 705/37; 705/39

(57) ABSTRACT

A financial and computer system for conducting commerce using electricity-backed certificates, comprising: a physical certificate or electronic representation thereof having a face value and denominated in units of electricity representing a specified amount of electricity to be provided to a user thereof, wherein said certificate has an indefinite lifetime, identifies an issuer and has a signature for verifying authenticity; wherein said certificate circulates to purchase general items of commerce; wherein any certificate holder may tender it to the issuer as payment for said specified amount of electricity; and wherein said specified amount of electricity is provided to a user thereof, which electricity is paid for by the issuer in redemption of said tendered certificate.

### FIELD OF THE INVENTION

Electricity-backed notes.

### BACKGROUND OF THE INVENTION

Modern economic theory suggests that wealth is best defined as “the capacity to consume,” but that usually depends on the constant use of energy—from design to production to storage to delivery to consumption. Since a given amount of electricity can be converted to a specific amount of work in the scientific sense, electricity has “real” value in that it can be measured objectively. Hence a money supply backed by a credible promise to exchange notes for a standard amount of electricity can be the basis for a money system.

Traditional money has had the attributes of being 1) portable, 2) difficult to counterfeit, 3) limited in supply, 4) non-perishable and 5) easy to recognize. While electricity itself meets none of these requirements, notes on paper, metal or in electronic form representing the right to buy electricity can do so in a well-ordered society.

Since electrical power would not be the only thing one might buy with such notes, the total face value in circulation could greatly exceed the amount of electricity that might be delivered. However, the money system of this invention will not be as prone to inflationary pressures as the fiat currency systems in use today world-wide, because the total electrical capacity of the system could be measured objectively and compared to the amount of electricity-backed notes in circulation. As a population grows its money supply should grow proportionately, because everyone needs money. But marginal megawatts may become increasingly expensive as new consumer demands or threats to the power supplies are perceived. Accordingly, the soundness of power-backed money will depend on the cost of creating and protecting electrical capacity, to avoid negative seigniorage. These conditions will place a practical limit on the number of notes that an issuer can put into circulation without debasing its currency.

The present notes can circulate as any currency does for buying goods and services: they should be physically accumulated, kept in savings accounts, in stock and bond investments (earning interest in Watt/hours) or real estate investments, and passed down to heirs: all without ever being redeemed for electricity.

Such notes should retain full or substantial value away from the power grids that back them, and during temporary blackouts, provided that the underlying promise to redeem them (somewhere) as payment for electricity remaines credible. That would mean the notes could ultimately be traded to someone who needed electricity and who felt able to buy and receive electricity from the entity that issued the notes. Such credibility would best come from the force of a national government to deal with counterfeiting and physical threats to plant and fuel supplies, but a regional power authority could issue regional money, just as private banks issued private money before the Federal Reserve System. Commercial entities, cooperatives, non-profit organizations and even individuals, which are not themselves electric utilities, may also issue electricity-backed notes of the invention if they are redeemable as payment for electricity provided to a user thereof.

Turk, et al., U.S. Pat. No. 5,983,207, discloses a computer system and method that allows gold to circulate as digital cash through the internet or private communication networks much like cash currently circulates in the physical world. A similar system can be used for exchanging electricity-backed notes. In Turk et al., a computer system creates digital representations of gold (ecoins). Each ecoin represents a weight of gold held at a participating secure storage facility (storage site), and each ecoin is given by the emint a unique signature by which it can be distinguished and identified. The sum total of all circulating ecoins (denominated in physical measures such as grams) equals the weight of all the gold held for safekeeping at the storage site(s) for the users of the emint. However, in the present invention the value of electricity-backed notes may greatly exceed the amount of electricity that can be delivered, as discussed below. In Turk et al. the ownership of gold is not transferred by a computer system executing debits and credits between individual accounts, but instead by individuals directly transferring ecoins amongst themselves (as is done in cash transactions, i.e., without double-entry bookkeeping). A similar system is appropriate for electricity-backed notes. The disclosure of Turk et al. is incorporated herein by reference in its entirety.

Nemzow, U.S. Pat. No. 6,721,715, describes dynamic methods for currency conversion, which can be applied to determining the value of electricity-backed notes in various national currencies. The disclosure of Nemzow is incorporated herein by reference in its entirety.

### SUMMARY OF THE INVENTION

One object of the invention is to provide a system for conducting commerce using electricity-backed certificates, which makes use of physical certificates or electronic representations thereof having a face value and denominated in units of electricity representing a specified amount of electricity to be provided to a user thereof, wherein said certificate has an indefinite lifetime, identifies an issuer and has a signature for verifying authenticity; wherein said certificate circulates to purchase general items of commerce; wherein any certificate holder may tender it to the issuer as payment for said specified amount of electricity; and wherein said specified amount of electricity is provided to a user thereof, which electricity is paid for by the issuer in redemption of said tendered certificate.

Another object is provide a computer system for using electricity-backed certificates in commerce, comprising: means for maintaining records of holders of electricity-backed certificates, said certificates having a face value and denominated in units of electricity representing a specified amount of electricity to be provided to a user thereof, having indefinite lifetimes, identifying issuing entities, and having signatures for verifying authenticity; means for transmitting said certificates to system users; means for certificate holders to tender them to their issuing entities as payments for said specified amounts of electricity; means for delivering said specified amounts of electricity to users thereof, which electricity is paid for by the issuing entities in redemption of their tendered certificates; and said computer system permitting users to conduct general financial transactions and purchase general items of commerce by using said electricity-backed certificates.

### DETAILED DESCRIPTION OF THE INVENTION

The true worth of notes or certificates having a face value of 1 kWatt/hour can be expressed in many ways. Provided the public believes that such notes will be honored by an electric utility or other issuer they represent exactly 3411.8 BTU, a physical quantity of energy. In terms of U.S. dollars, in 2007, they would represent about 10 cents (including delivery fees) worth of electricity. A year later they could be worth 11 cents, two years later maybe 15 cents. While the prices in dollars, euros and gold might go up or down, their value as energy remains constant if the promise to redeem each for exactly 1 kilowatt/hour of electricity remains credible (somewhere).

The present invention is a system for conducting commerce or trade, meaning the buying and selling of goods, especially on a large scale, as between cities or nations, using electricity-backed paper certificates, metal coins or electronic representations thereof. Trade includes buying and selling between individuals of goods, services and securities on domestic or international markets.

The present certificates have a face value and are denominated in units of electricity representing a specified amount of electricity to be provided to a user thereof. In order to retain value such certificates have an indefinite lifetime, and thus are not to be considered futures contracts, put options or call options. Preferably the certificates of the invention are negotiable but may be non-negotiable.

Each certificate identifies an issuer and preferably has a unique signature for verifying authenticity, such as a serial number or a non-specific signature such as a watermark. Such certificates may circulate in the population to purchase general items of commerce including electricity (e.g., as payment to an electric utility that did not issue the certificates), without being tendered to or redeemed by the issuer. But the certificates may also be redeemed specifically for electricity when a certificate holder tenders it to the issuer as payment for the amount of electricity specified on the note. Then that specified amount of electricity is provided to a user of electricity and is paid for by the issuer in redemption of said tendered certificate.

The potential ability to tender notes (somewhere) for electricity is what preserves their value to the general public. In order to facilitate trade for any item, such certificates may specify a range of values, e.g., amounts of electricity selected from the group consisting of 0.1, 1, 10 and 100 kWh (kilowatts/hour). Even larger denominations would be useful in many situations just as with conventional money.

In one embodiment the certificates do not identify any particular holder or beneficial owner. In another embodiment the certificates identify a beneficial owner, optionally wherein redemption of a tendered certificate is permitted only on behalf of the identified beneficial owner. Examples of such certificates are traveler's checks and drafts on a demand checking account of electricity-backed currency.

Certificate issuing entities may include electric utilities, for-profit companies, not-for-profit charitable organizations, mutually owned companies, local governments, government sponsored entities, and national governments. Such issuing entities would promise to accept their certificates in a redemption process as payment for electricity produced or delivered by an electric utility to a user thereof.

Electricity bills often include delivery fees and taxes which must be paid by consumers of electricity. Accordingly, certificates of this invention may be redeemed as full payment, including fees and taxes, associated with providing the face value amount of electricity to a user thereof.

Electricity typically varies in price according to location and the size of the user. For instance, industrial customers often pay less per kWh than household consumers of electricity. A certificate issuer may restrict the geographical area in which its notes can be redeemed as payment for electricity, and may issue different classes of notes, e.g., consumer vs. industrial users.

In order to deter counterfeiting, system users may consult a database of signatures, such as unique serial numbers on the notes, to determine if a given note has previously been redeemed in payment for its specified amount of electricity. In one embodiment, when a signature is verified it is cancelled and replaced by another signature. This method is most appropriate for electronic certificates. In another embodiment, the system verifies a first signature and sends back an additional code, such as a one-, two- or three-digit number or letter combination, that is added (e.g., by hand) to the end of the first signature, forming a second signature, which becomes the new signature for that note.

In one embodiment, in order to pay for electricity any holder may tender a certificate to its issuer. If such entity is not itself an electric utility, it then pays an electric utility, identified by the holder for the amount of electricity specified on the certificate, on behalf of the holder.

In another embodiment any holder may tender a certificate to its issuer, which then pays an electric utility identified by the issuer, for the specified amount of electricity, on behalf of the holder.

As part of commercial transactions the certificates may be sold to a broker or dealer in exchange for other forms of money, such as gold, a national currency, or a security denominated in a national currency (e.g, a fixed- or floating-interest rate debt obligation or equity), or another type of electricity-backed certificate. Preferably such a dealer acts as a public market maker, buying or selling said certificates. Brokers may arrange such transactions for a commission without taking a proprietary position.

An independent rating agency may research the soundness of various issuers of electricity-backed certificates and provide quality ratings similar to bond ratings.

Dealers may underwrite the issuance or distribution of electricity-backed certificates from an issuer to brokerage customers in a primary market. Dealers may also act as market makers in a secondary market, e.g., by exchanging a first certificate issued by a first issuer for money or for a second certificate which may be issued by the same issuer or a second issuer. In one embodiment the first and second certificates are issued by the same entity but have different seniority or preference classes.

Islamic banking is meant to be consistent with Islamic law (Shariah) principles. In particular, Islamic law prohibits usury, the collection and payment of interest, also commonly called riba in Islamic discourse. Generally, Islamic law also prohibits trading in financial risk (which is seen as a form of gambling). Because the amount of electricity represented by a given electricity-backed certificate is a constant, it can become the basis for a loan that does not formally involve the payment of interest However, in terms of national currencies, which tend to inflate over time, such certificates would pay interest in effect.

In general, the total amount of electricity represented by the sum of all certificates from the issuer may greatly exceed the amount of electricity that can be delivered over a given time period (e.g., in one year) from the electric facilities backing the notes, e.g from 2:1 to 100:1 or more.

A computer system for using electricity-backed certificates in commerce has means for maintaining records of holders of electricity-backed certificates similar to conventional systems for tracking securities accounts and demand checking accounts. The computer system can check certificate signatures to verify authenticity of physical notes or electronic representations thereof; transmits certificates to system users, has means for recording that certificate holders have tendered them to their issuing entities as payments for the amount of electricity specified thereon; and can direct an electric utility to produce or deliver the specified amount of electricity to users thereof, which electricity is paid for by the issuing entities in redemption of their tendered certificates; and the computer system permitts users to conduct general financial transactions and purchase general items of commerce by using said electricity-backed certificates.

The computer system maintains a database of signatures or serial numbers whereby a system user may determine if a certificate has been previously redeemed as payment for said specified amount of electricity. The computer system may permit users to submit the signature of a first electronic certificate for authentication, the system consults said database of signatures to ensure that the submitted certificate has not been previously redeemed as payment for electricity, and, if not, records the first certificate as cancelled and creates a second signature and transmits it to a system user. In one embodiment, the user writes the new signature on an original physical certificate, which can inhibit counterfeiting of physical notes.

The computer system may subtract an amount of electricity representing transactional costs from the amount of electricity to be provided on a first certificate, to determine the amount of electricity to be provided on a second certificate. In one embodiment, a user may request that a first certificate be exchanged for a second certificate, credited to an account of a system user, or transferred to a third party.

The computer system may record certificates issued by an electric utility and redeemed as payment for electricity produced or delivered by said electric utility. In one embodiment the certificate is further redeemed as payment for fees and taxes associated with providing the amount of electricity specified on its face to a user of electricity.

The computer system may facilitate payment to an issuer that is not itself an electric utility. In general any holder may tender a certificate to its issuer through the computer system, which then pays an electric utility identified by the holder, for said specified amount of electricity, on behalf of said holder

The computer system may be adapted so that certificates may be sold to a dealer in exchange for a national currency, a security denominated in a national currency, or another electricity-backed certificate. Such dealers may use the system to act as public market makers in a secondary market, buying or selling said certificates. Dealers may also act as market makers buying or selling a first certificate issued by a first issuer in exchange for a second certificate which may be issued by a second issuer.

The computer system permits a dealer to underwrite the issuance or distribution of electricity-backed certificates in a primary market from the issuer to brokerage customers. In one embodiment, the computer system works with certificates that do not identify any holder or beneficial owner, preferably such notes are negotiable. In another embodiment, the computer system works with certificates that identify a beneficial owner. In another embodiment, the computer system works with certificates or notes that are traveler's checks, wire transfers or personal checks.

In one embodiment the computer system tenders a certificate to its issuer, which then pays an electric utility identified by the issuer, for said specified amount of electricity, on behalf of the holder.

Redemption of electricity-backed notes will remove them from circulation. If the issuer is a government, such notes can be recycled as government spending when electric utility bills are paid. This financial cycle may thus function as an income tax.

Protection of power supplies backing a national or international money system would become a matter of utmost national security. War and terrorism would become truly costly to every trading nation. Such risks should promote greater concern for the overall well being of society and the resulting social benefits could offset the risks.

While currency/electricity-backed note conversion is at face value a simple mathematical process, some obstacles include valuing the currency itself, consideration of electricity costs in different locations where the certificates may be traded, and the complexity of rate data. Currency and electricity rate data comprise historical rates, prior market close rates, delayed market rates, immediate market rates, future rates (forecasts and with interest-bearing components), options (bets as to future price for sales or acquisition of a currency or electricity), stripped bonds, and any other financial instruments. Currency and electricity-backed certificate rates may also vary depending on factors such as direction of translation, bids, asks, transaction size-dependencies, and whether data on specific dates/times/currency pairs are missing or unavailable.

A reliable currency translation system can be based on translation from an original currency basis to an objective currency target through one or more intermediate currencies or electricity-backed certificates, taking account of transaction costs and spreads where bid and ask or future contracts can substantially devalue the results.

It should be understood that the examples and embodiments described herein are for illustrative purposes only. Various modifications or changes in light thereof will be suggested to persons skilled in the art and are included within the spirit of this disclosure and the scope of the appended claims.

1. A system for conducting commerce using electricity-backed certificates, comprising: a physical certificate or electronic representation thereof having a face value and denominated in units of electricity representing a specified amount of electricity to be provided to a user thereof,
wherein said certificate has an indefinite lifetime, identifies an issuer and has a signature for verifying authenticity;
wherein said certificate circulates to purchase general items of commerce;
wherein any certificate holder may tender it to the issuer as payment for said specified amount of electricity; and
wherein said specified amount of electricity is provided to a user thereof, which electricity is paid for by the issuer in redemption of said tendered certificate.

2. The system of claim 1, wherein a certificate specifies an amount of electricity selected from the group consisting of 0.1, 1, 10 and 100 kWatt/hour.

3. The system of claim 1, wherein said issuer that is not an electric utility.

4. The system of claim 1, wherein said certificate is further redeemed as payment for fees and taxes associated with providing said specified amount of electricity to a user thereof.

5. The system of claim 1, wherein any holder may tender a certificate to its issuer, which then pays an electric utility identified by the holder, for said specified amount of electricity, on behalf of said holder.

6. The system of claim 1, wherein any holder may tender a certificate to its issuer, which then pays an electric utility identified by the issuer, for said specified amount of electricity, on behalf of the holder.

7. The system of claim 1, wherein a dealer underwrites the issuance or distribution of said certificates from the issuer to brokerage customers.

8. The system of claim 1, wherein financial transactions are consistent with Islamic law's prohibition against payment of interest.

9. The system of claim 1, wherein said certificate is a member selected from the group consisting of a traveler's check, a wire transfer payment and a draft on a demand checking account.

10. The system of claim 1, wherein the total amount of electricity represented by all certificates from the issuer exceeds the amount of electricity that can be delivered in one year by electric facilities backing those certificates by at least 2:1.

11. A computer system for using electricity-backed certificates in commerce, comprising: means for maintaining records of holders of electricity-backed certificates, said certificates having a face value and denominated in units of electricity representing a specified amount of electricity to be provided to a user thereof, having indefinite lifetimes, identifying issuing entities, and having signatures for verifying authenticity;
means for transmitting said certificates to system users;
means for certificate holders to tender them to their issuing entities as payments for said specified amounts of electricity;
means for delivering said specified amounts of electricity to users thereof, which electricity is paid for by the issuing entities in redemption of their tendered certificates;
and said computer system permitting users to conduct general financial transactions and purchase general items of commerce by using said electricity-backed certificates.

12. The computer system of claim 11, comprising a database of said signatures whereby a system user may determine if a certificate has been previously redeemed as payment for said specified amount of electricity.

13. The computer system of claim 12, in which a system user may submit a first electronic certificate for authentication, the system consults said database of signatures to ensure that the submitted certificate has not been previously redeemed as payment for electricity, and, if not, records the first certificate as cancelled and creates a second certificate and transmits said second certificate to a system user.

14. The computer system of claim 13, which subtracts an amount of electricity representing transactional costs from said specified amount of electricity to be provided on the first certificate, to determine the specified amount of electricity to be provided on the second certificate.

15. The computer system of claim 11, wherein a user may request that a first certificate be exchanged for a second certificate, credited to an account of a system user, or transferred to a third party.

16. The computer system of claim 11, wherein said certificate is further redeemed as payment for fees and taxes associated with providing said specified amount of electricity to a user thereof.

17. The computer system of claim 11, wherein said issuer is not an electric utility.

18. The computer system of claim 11, wherein a dealer acts as a market maker in a secondary market, buying or selling a first certificate issued by a first issuer in exchange for a national currency or a second certificate which may be issued by a second issuer.

19. The computer system of claim 11, wherein the total amount of electricity represented by all certificates from the issuer exceeds the amount of electricity that can be delivered in one year by electric facilities backing those certificates by at least 2:1.

20. The computer system of claim 11, wherein a first currency amount is translated into a second currency amount through calculation of their respective values in terms of an electricity-backed certificate.
